(19) United States
(12) Patent Application Publication
(10) Pub. No.: US 2011/0034227 A1
(43) Pub. Date: Feb. 10, 2011

(54) REACTION-TRAINING GAME MACHINE

(76) Inventor: Wei-Hsuan WU, Taipei City (TW)

Correspondence Address: Guice Patents PLLC, 12647 Galveston Court #302, Manassas, VA, 20112, US

(21) Appl. No.: 12/535,781

(22) Filed: Aug. 5, 2009

(51) Int. Cl. A63F 9/24; A63F 13/00

(52) U.S. Cl. 463/7; 463/37

(57) ABSTRACT

A reaction-training game machine includes a machine table holding a host system therein, a display mounted in the top wall of the machine table and controllable to display game images, and one operation controller installed in the machine table at each of two opposite lateral sides, each operation controller providing a set of buttons for pressing by a player to generate one respective virtual bumper block from one lateral edge of the display at a respective location. The host system generates one virtual moving ball on the display when the reaction-training machine is started up, and the virtual moving ball bounces when touched the top or bottom edge of the display or one bumper block at one lateral edge of the display, or one point deduction is made to the score of the player when the virtual moving ball touches one lateral edge of the display. The game is over when the energy table for one player is used up.

### BACKGROUND OF THE INVENTION

1. Field of the Invention

The present invention relates to game machines and more particularly, to a reaction-training game machine for training the reaction ability of a person.

2. Description of the Related Art

In addition to entertainment value, a game machine can be designed for training the reaction ability of a person.

There is known a reaction capacity-training game machine for playing a reaction game each player holds and slides a master member on a flat top surface of the machine table to stop or hit a thin disk-like slave member. This game machine is practical for training the reaction ability of a person. However, the game must be performed by two players. One person cannot play the game to entertain oneself. Further, when hitting the master member against the slave member, a noisy sound is produced. Further frequently hitting the master member against the slave member causes the master member and the slave member to wear. Improvements are necessary.

Further, there are ping-pong TV game machines in which a joystick or buttons are operated to move a baffle in stopping a ping pong ball, achieving entertainment effects. However, these ping-pong TV game machines provide limited manipulation functions and entertainment effects, rendering little help in reaction training.

### SUMMARY OF THE INVENTION

The present invention has been accomplished under the circumstances in view. It is one object of the present invention to provide a reaction-training game machine, which is practical for training the reaction ability of a person. It is another object of the present invention to provide a reaction-training game machine, which provides a single player mode and a 2-player mode for selection.

To achieve these and other objects of the present invention, a reaction-training game machine comprises a machine table holding a host system therein, a display mounted in the top wall of the machine table and controllable to display game images, and one operation controller installed in the machine table at each of two opposite lateral sides, each operation controller providing a set of buttons for pressing by a player to generate one respective virtual bumper block from one lateral edge of the display at a respective location. The host system generates one virtual moving ball on the display when the reaction-training machine is started up. When the virtual moving ball touches the top or bottom edge of the display or one bumper block that protrudes from one lateral edge of the display, the virtual moving ball moves in a bounce direction. When the virtual moving ball touches one lateral edge of said display, one point deduction is made to the score of the player.

Further, the host system is controllable to generate one of a group of obstacles on the display, thereby increasing the level of game difficulty and creating a game interesting level. Further, the group of obstacles includes a fixed object, a free moving object, a movable object and a set of barriers.

### BRIEF DESCRIPTION OF THE DRAWINGS

FIG. 1 is a perspective view of the outer appearance of a reaction-training game machine in accordance with the present invention.

FIG. 2 is a circuit block diagram of the present invention.

FIG. 3 is an operation flow chart of the host system of the reaction-training game machine in accordance with the present invention.

FIG. 4 is a top plain view of the present invention, showing bumper blocks displayed on the display.

FIG. 5 is a schematic plain view of the present invention, showing definition of moderate speed, high speed and super high speed of the bumper blocks.

FIG. 6 is a schematic drawing showing the reaction-training game machine operated under a single player mode.

FIG. 7 is a schematic top plain view of the present invention, showing one fixed object appeared on the display.

FIG. 8 is a schematic top plain view of the present invention, showing one free moving object appeared on the display.

FIG. 9 is a schematic top plain view of the present invention, showing one movable object appeared on the display.

FIG. 10 is a schematic top plain view of the present invention, showing a set of barriers appeared on the display.

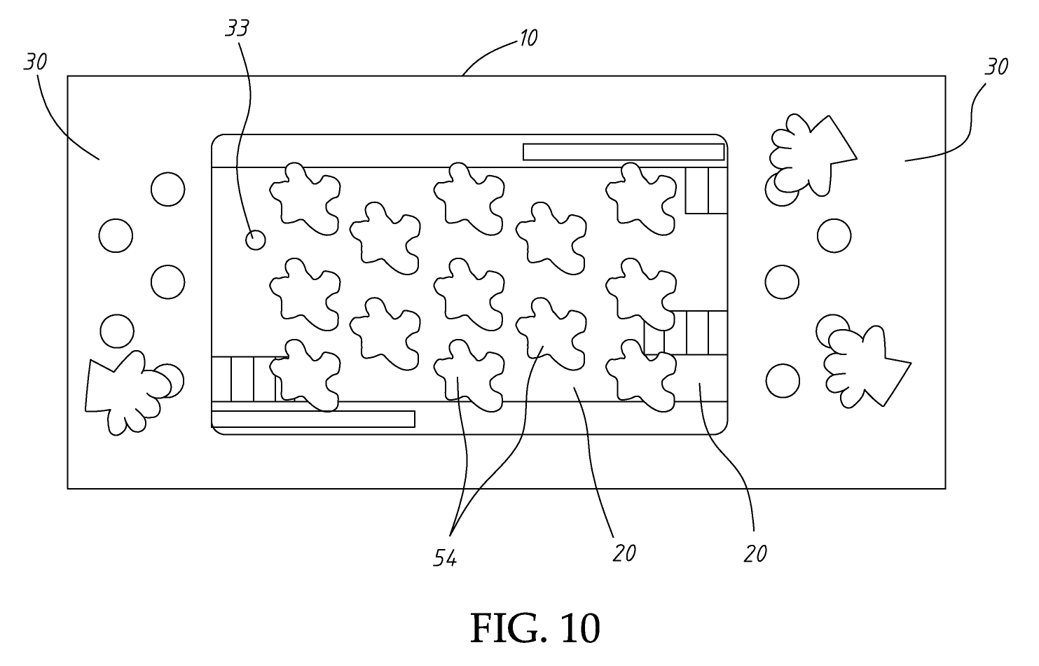

FIG. 11 is a schematic top plain view of the present invention, showing one parallel moving object appeared on the display.

### DETAILED DESCRIPTION OF THE PREFERRED EMBODIMENT

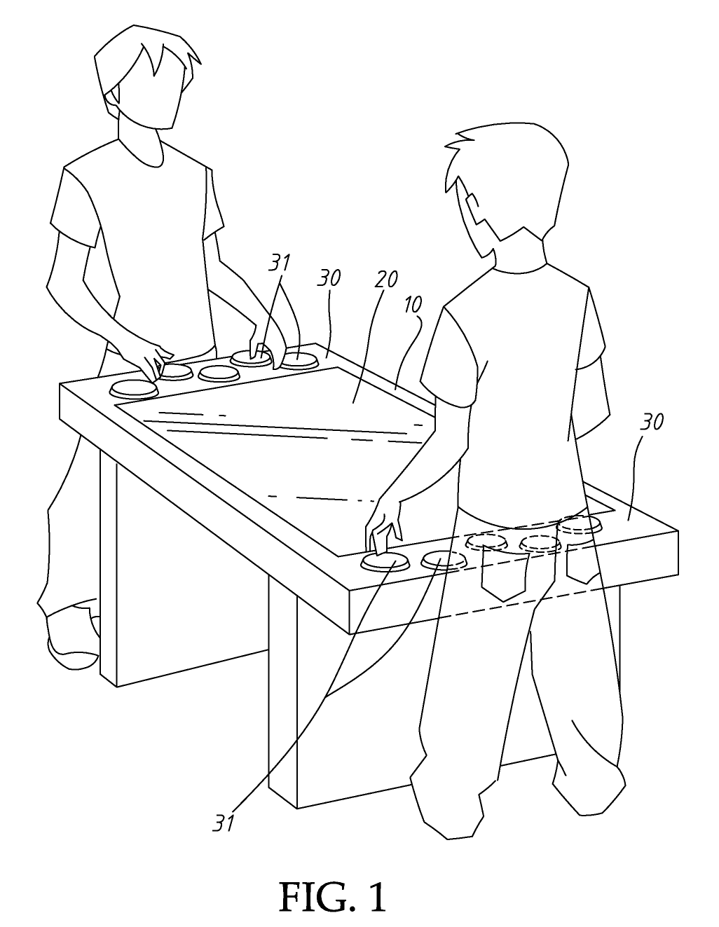

Referring to FIGS. 1˜3, a reaction-training game machine in accordance with the present invention is shown comprising a machine table 10, a display 20 and two operation controllers 30.

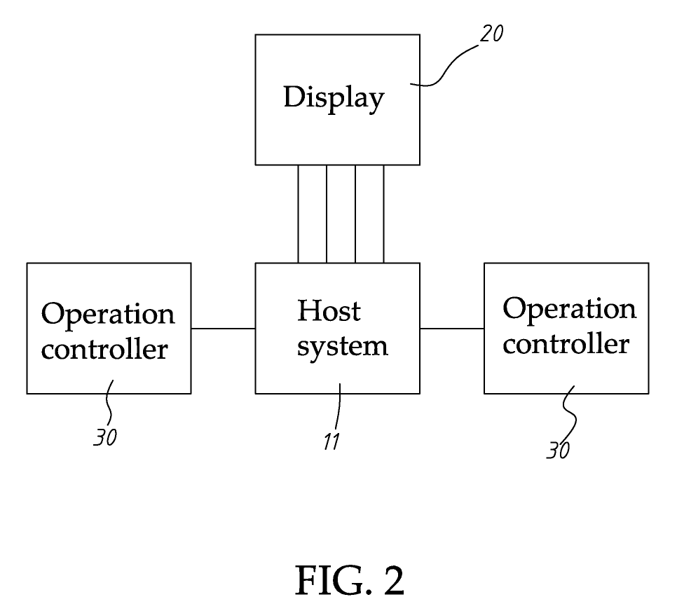

The machine table 10 accommodates therein a host system 11 (see FIG. 2). The display 20 is horizontally mounted in the top wall of the machine table 10 on the middle and controllable to display game images. The two operation controllers 30 are respectively located on the top wall of the machine table 10 at two opposite sides relative to the display 20. Each operation controller 30 comprises a predetermined number of operation buttons, for example, 5 operation buttons 31 for pressing by a hand 4 of a player. When one operation button 31 is pressed by a player, the host system 11 is triggered to output a corresponding control signal to the display 20, causing the display 20 to display a bumper block 32 at a location corresponding to the operation button 31 been pressed.

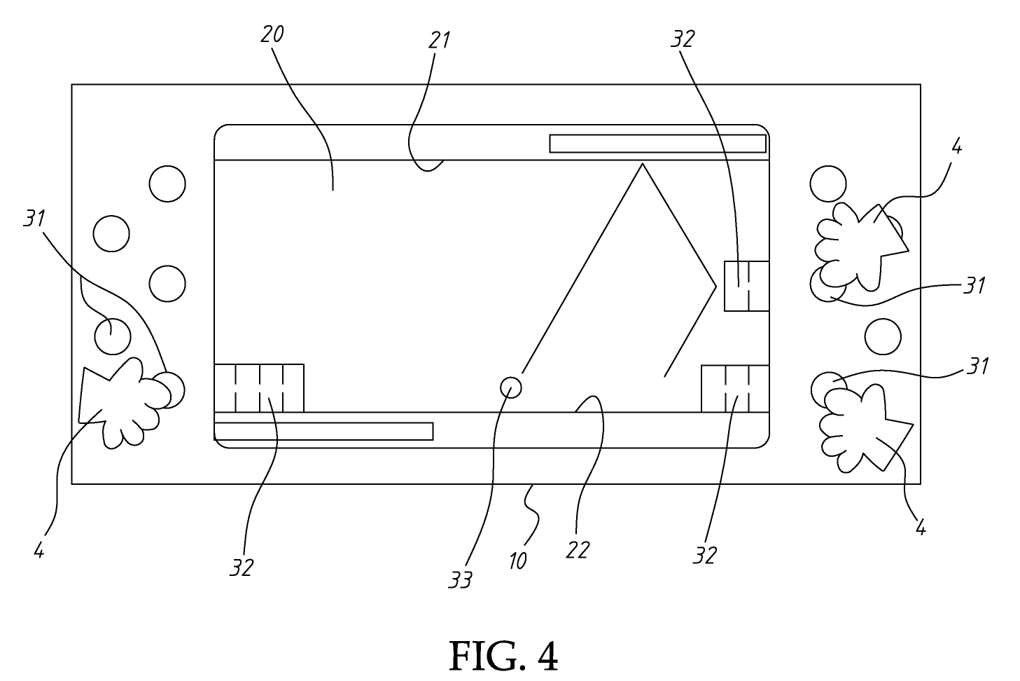

The host system 11 drives the display 20 to display one or multiple moving balls 33 (see FIG. 4) when the reaction-training game machine is started up. When one moving ball 33 touches the top edge 21 or bottom edge 22 of the display 20 or one bumper block 32 that protrudes from one of two opposite lateral edges of the display 20, the moving ball 33 will move in the bounce direction. If the moving ball 33 is not stopped by one bumper block 32 and touches one lateral edges of the display 20, one point or a predetermined number of points will be deducted from the score of the corresponding player.

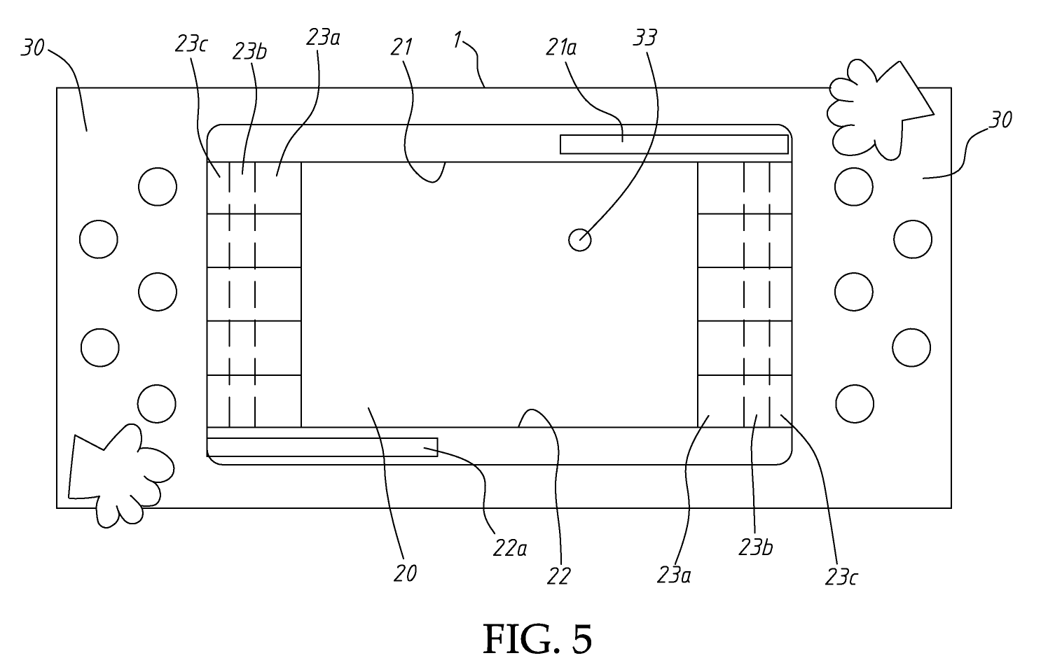

The host system 11 provides a ball speed variation design. As shown in FIG. 5, subject to the protruding distance of one bumper block 32 from one lateral edge of the display 20, the bumper block 32 causes the moving ball 33 to move at one of three speeds, the moderate speed 23a, the high speed 23b and the super high speed 23c. When the moving ball 33 touched one bumper block 32 having a different length, the moving ball 33 immediately changes its moving speed. Further, two energy tables 21a and 22a are provided at the top wall of the machine table 10 and respectively abutted against the top edge 21 and bottom edge 22 of the display 20 and respectively disposed near one of the two opposite lateral edges of the display 20 for indicating the score of one respective player. When one player missed the moving ball once, the corresponding energy table 21a or 22a shows a score point deduction. When the score shown in one energy table 21a or 22a is zeroed, the game is over.

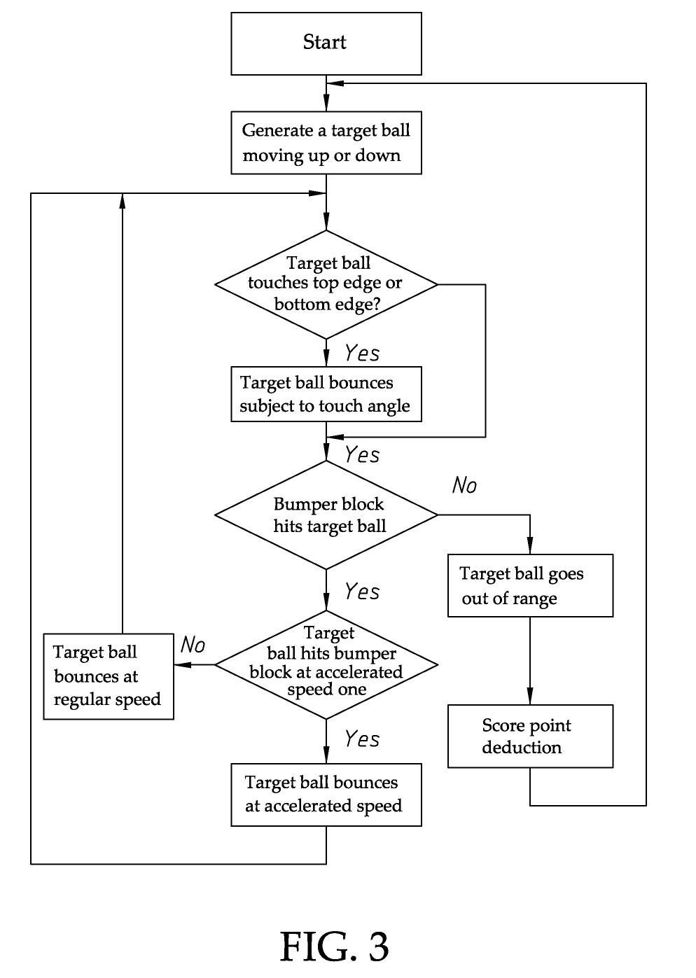

When playing the reaction-training game machine, as shown in FIGS. 2 and 4 again, one player can press one operation button 31 with one hand 4 to trigger the host system 11, causing the display 20 to be driven by the host system 11 to display a bumper block 32 at a location corresponding to the operation button 31 been pressed for stopping the moving ball 33 and making the moving ball 33 to bounce. If the player selected a wrong button, the moving ball 33 will not be stopped by a bumper block and will touch one lateral edge of the display 20. At this time, a corresponding score point deduction will be made. The operation flow of the host system 11 can be referred to FIG. 3. When one target ball is produced, judge the touch condition and touch location, and then control bouncing and speed of the target ball, and then execute score point deduction when the target ball goes out of the range.

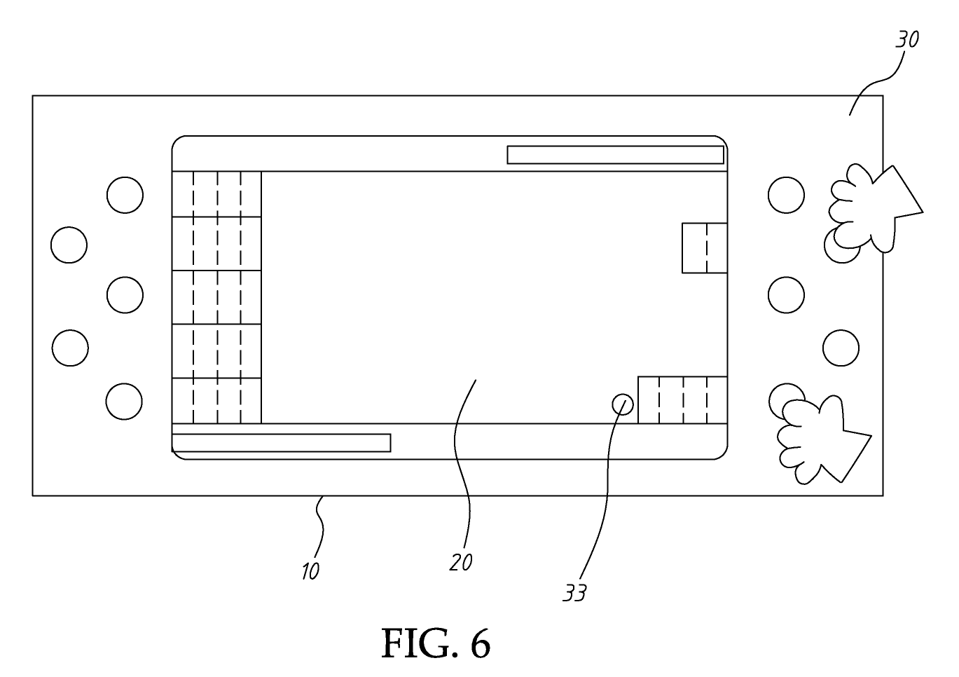

Referring to FIG. 6, the reaction-training game machine can be made having only one operation controller 30 mounted on the top wall of the machine table 10 at one lateral side for playing by one player to fight against the host system 11. Alternatively, the reaction-training game machine can be made having two operation controllers 30, and the host system 11 provides a selection for single player mode or 2-player mode.

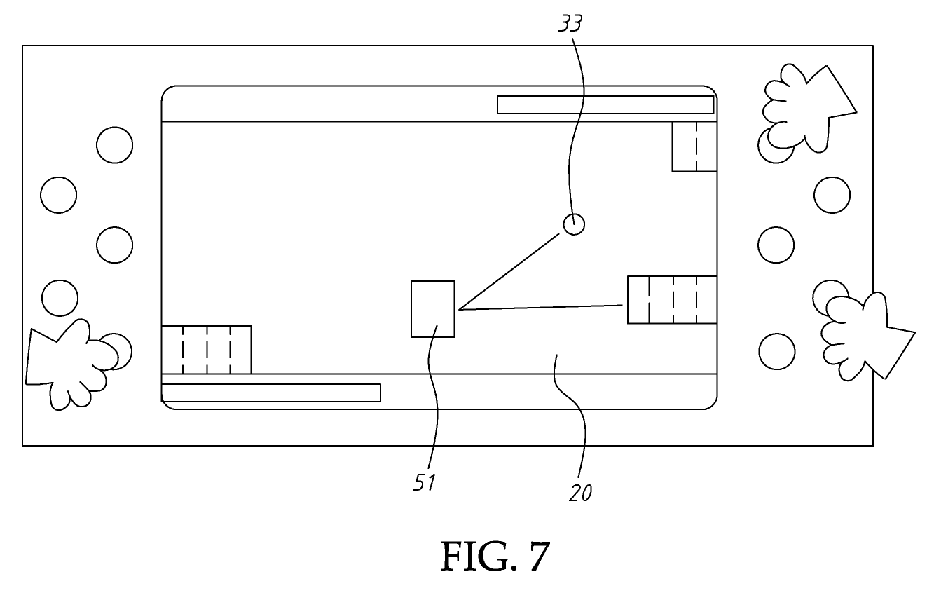

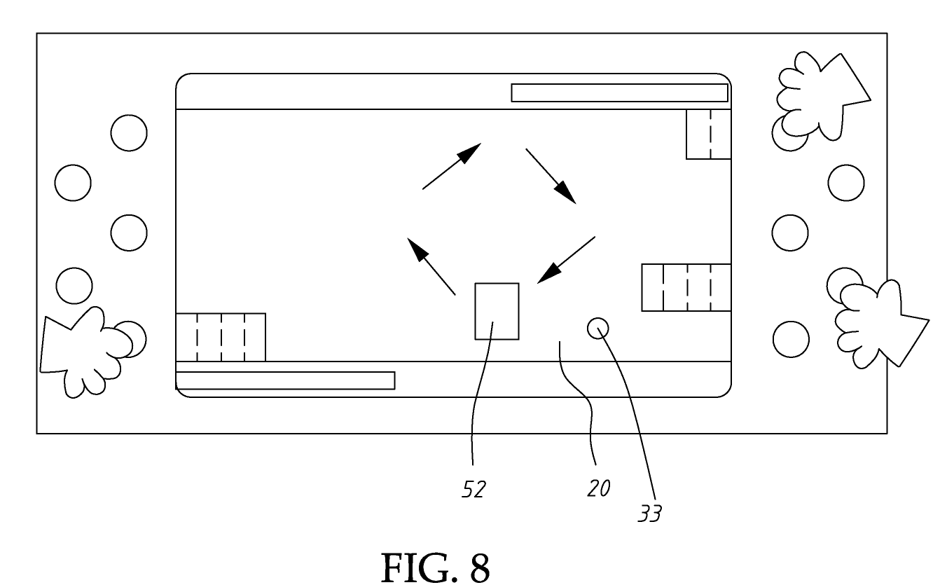

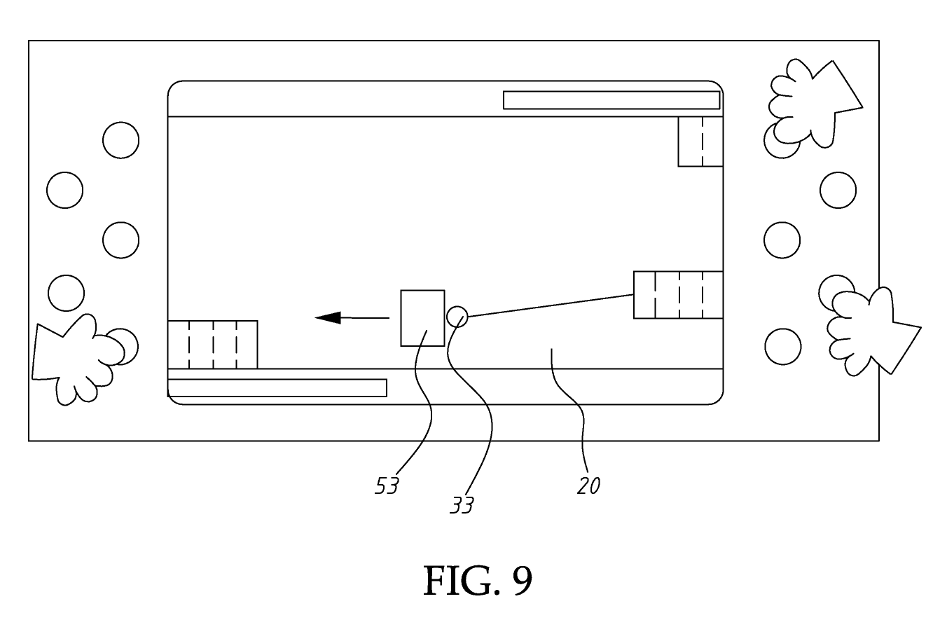

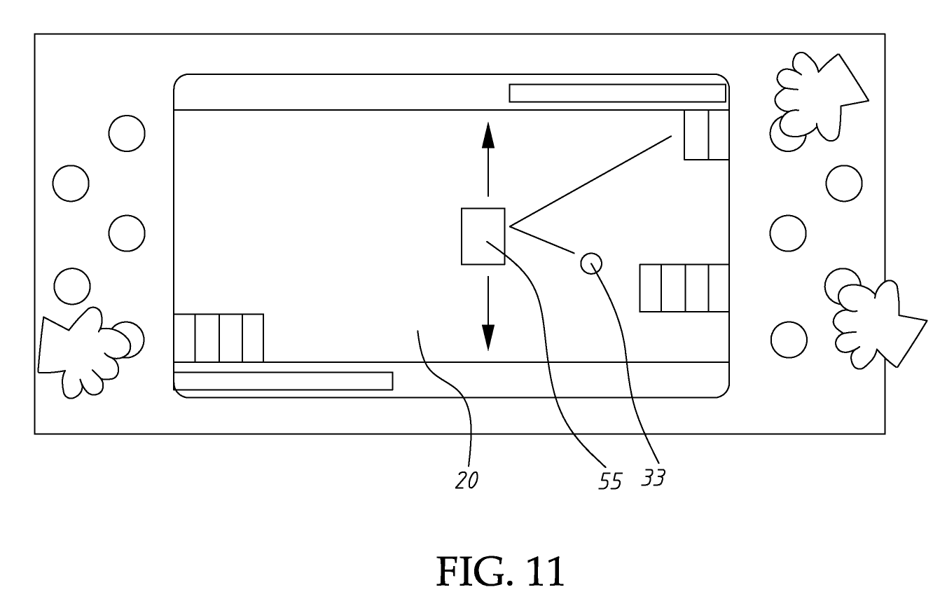

Referring to FIGS. 7˜11, the host system 11 can be controlled to drive the display 20 to display obstacle means. The obstacle means can be a fixed object 51, a free moving object 52, a movable object 53, barriers 54 or a parallel moving object 55. When the ball 33 touches the fixed object 51 shown in FIG. 7, the ball will bounce. When the ball 33 touches the free moving object 52 that moves subject to a predetermined track as shown in FIG. 8, the ball 33 will make a reflective movement. When the ball 33 touches the movable object 53 shown in FIG. 9, the ball 33 will move the movable object 53. When the barriers 54 are shown on the display 20, the ball 33 is moving beneath the barriers 54, and the barriers 54 do not hinder movement of the ball 33 but simply block the players' sight from viewing therethrough to see the movement of the ball 33, increasing the level of game difficulty and creating a game interesting level. When the ball 33 touches the parallel moving object 55 shown in FIG. 11, the parallel moving object 55 will move up or down in a parallel manner. Further, the parallel moving object 55 can be combined with the free moving object 52 to create a different game interesting level.

A prototype of reaction-training game machine has been constructed with the features of FIGS. 1˜11. The reaction-training game machine functions smoothly to provide all of the features disclosed earlier.

Although particular embodiments of the invention have been described in detail for purposes of illustration, various modifications and enhancements may be made without departing from the spirit and scope of the invention. Accordingly, the invention is not to be limited except as by the appended claims.

What the invention claimed is:

1. A reaction-training game machine, comprising:
a machine table holding a host system therein, said machine table having a top wall;
a display mounted in the top wall of said machine table and controllable to display game images, said display having a top edge, a bottom edge and two opposite lateral edges connected in parallel between said top edge and said bottom edge; and
at least one operation controller installed in said machine table, each said operation controller comprising a set of buttons arranged on the top wall of said machine table at one lateral side relative to said display for pressing by a player to generate one respective virtual bumper block from one lateral edge of said display at a respective location;
wherein said host system generates at least one virtual moving ball on said display when the reaction-training machine is started up; when one said virtual moving ball touches one of the top and bottom edges of said display or one bumper block that protrudes from one lateral edge of said display, the virtual moving ball moves in a bounce direction; when one said virtual moving ball touches one lateral edge of said display, one point deduction is made to the score of the player.

2. The reaction-training game machine as claimed in claim 1, wherein the number of said at least one operation controller is 2, and the two operation controllers are installed in said machine table at two opposite lateral sides relative to said display.

3. The reaction-training game machine as claimed in claim 1, wherein the operation buttons of each said operation controller are controllable to generate different lengths of virtual bumper blocks from one lateral edge of said display at different locations for causing said virtual moving ball to move at one of a moderate speed, a high speed and a super high speed.

4. The reaction-training game machine as claimed in claim 1, wherein said host system is controllable to generate one of a group of obstacles on said display, said group of obstacles including a fixed object, a free moving object, a movable object and a set of barriers.

5. The reaction-training game machine as claimed in claim 1, further comprising two energy tables provided at the top wall of said machine table and respectively abutted against the top edge and bottom edge of said display and respectively disposed near one of the two opposite lateral edges of said display and controllable by said host system to indicate the score of one respective player.
